(19) United States
(12) Patent Application Publication
(10) Pub. No.: US 2002/0180115 A1
(43) Pub. Date: Dec. 5, 2002

(54) Method and apparatus for in-mold separation of integrally attached gutter flash from a blow-molded thermoplastic resin product

(76) Inventor: Bruce V. Weeks, Pataskala, OH (US)

Correspondence Address: Weeks, Bruce V, 5874 Blendon Place Drive, Columbus, OH, 43230, US

(21) Appl. No.: 09/873,532

(22) Filed: Jun. 4, 2001

(51) Int. Cl. B29C 49/50

(52) U.S. Cl. 264/536; 425/527

(57) ABSTRACT

A production method is disclosed for separating integrally attached gutter flash from a blow-molded thermoplastic resin product utilizing tensile forces applied to the gutter flash while the product remains fully restrained within the blow-mold assembly in which it is formed, as well as different embodiments of apparatus suitable for utilization in a conventional industrial blow-molding machine to accomplish the production method.

### CROSS-REFERENCES

None.

### FIELD OF THE INVENTION

The present invention relates generally to the manufacture of blow-molded thermoplastic products, and particularly concerns both a method and apparatus for accomplishing the separation of integrally formed gutter flash from a blow-molded product while the product is completely restrained by the product mold cavity of the apparatus.

### BACKGROUND OF THE INVENTION

It is common practice in the United States in connection with the manufacture of blow-molded thermoplastic resin products using conventional production blow-molding machines and known blow-mold assemblies to eject the molded product from the mold assembly with the simultaneously formed gutter flash integrally attached, and to afterwards completely separate the integrally attached gutter flash from the ejected blow-molded product by subsequently performed combined operations such as sequential cutting and grinding or sequential shearing and grinding. Such subsequent operations are extremely time-consuming and expensive from a labor and tooling cost standpoint. The required flash separation and removal costs and forces are especially substantial in cases where the blow-molding machine production cycle unit output is comprised of either a single blow-molded product or multiple blow-molded products, but each with integrally attached gutter flash having either a substantial thermoplastic resin material wall thickness or a substantial total length of gutter flash trim edge, or both.

In the teachings of U.S. Pat. No. 5,480,607 granted to Hobson a method of separating integrally attached flash from a product during the molding process is disclosed, but such method utilizes a step wherein the flash is temporarily secured to the apparatus blow-mold and the formed product is separated from the restrained integral flash by applying product mold ejector pin forces to the blow-molded product with the mold assembly in a partially-open condition. The ejection forces required may be undesirably large and generally cause ejector pin damage to the formed product in high-rate production cycles wherein the blow-molded product has an elevated temperature and a substantial degree of residual parison plasticity at time of gutter flash separation and product ejection from within the mold cavity.

I have discovered a cost-saving novel method of separating integrally attached gutter flash from a blow-molded product and also novel mold assembly constructions and a methods of assembly operation that may be used in conjunction with use of a conventional production blow-molding machine to achieve complete separation of otherwise integrally attached gutter flash from blow-molded products while the products are fully restrained by the mold apparatus and prior to product ejection from within the mold apparatus. Subsequently the individual blow-molded thermoplastic resin products and separated gutter flash are sequentially ejected from the mold assemblies in which they were formed and removed from the co-operating conventional production blow-molding machine. Because very short blow-molding machine operating cycle unit times may be achieved with the novel in-mold product de-flashing, and because the apparatus takes advantage of separated product and gutter flash removal procedures, the blow-molded thermoplastic resin products and separate gutter flash have no possibility of being inadvertently fused together.

Other objects and advantages of the present invention will become apparent during consideration of the detailed descriptions, drawings, and claims which follow.

### SUMMARY OF THE INVENTION

The method of the present invention involves a basic step sequence of blow-molding an extruded and heated thermoplastic resin parison contained within co-operating blow-mold subassemblies to form a blow-molded product having integrally attached gutter flash, separating the integrally attached gutter flash from the blow-molded product both while the molded product is fully restrained by the assembled mold sub-assemblies until gutter flash separation from the product is complete, and afterwards separating (opening) the closed product mold sub-assemblies for the purpose of removing the product and separated gutter flash from the blow-mold apparatus. The forces applied to the gutter flash during such gutter flash separation are tension forces rather than otherwise conventional cutting (wedging) forces or shearing forces.

The blow molding apparatus of the present invention is adapted to be readily installed for utilization in a conventional industrial blow-molding system or machine, and basically is comprised of a base blow-mold sub-assembly having one or more product molds, a co-operating cap blow-mold sub-assembly having a corresponding number of product molds complementary to and in registration with the base blow-mold assembly molds, a relatively movable gutter plate that surrounds each base blow-mold sub-assembly product mold, a relatively movable gutter plate that surrounds each cap blow-mold sub-assembly product mold, at least one bi-directional actuator for moving said base blow-mold assembly gutter plate, at least one bi-directional pneumatic actuator for moving the cap blow-mold sub-assembly gutter plate, and a programmable valve sequence control for properly sequentially actuating the different blow-mold assembly actuators throughout the complete production cycle of the blow-molding machine incorporating the apparatus.

### BRIEF DESCRIPTION OF THE DRAWINGS

FIG. 1 is a schematic perspective view of a conventional production blow-molding machine within which the methods and apparatus of the present invention may be practiced;

FIG. 2 is a schematic elevation view of the interior of the blow-molding machine of FIG. 1 illustrating one embodiment of the blow-mold sub-assemblies of the present invention in a fully separated condition;

FIG. 3 is similar to FIG. 2 except that the included invention blow-mold sub-assemblies are illustrated in an operationally-closed condition;

FIG. 4 is a plan section view taken at line 4-4 of FIG. 3;

FIG. 5 is an isometric view of one of the product blow-mold sub-assemblies shown in FIGS. 2 through 4;

FIG. 6 is an elevation section view taken at line 6-6 of FIG. 4 at completion of an in-mold intermediate product blow-forming step;

FIG. 7 is an elevation section view taken at line 6-6 of FIG. 4 at the completion of an in-mold intermediate gutter flash separation step;

FIG. 8 is an enlarged view of a designated portion of FIG. 6;

FIG. 9 is an enlarged view of a designated portion of FIG. 7;

FIG. 10 is an isometric view of the gutter flash ejected from the invention product mold assemblies following completion of the invention in-mold gutter flash separation step;

FIG. 11 is an isometric view of the generally cylindrical, hollow thermoplastic product blow-molded in one of the mold cavities of the invention product multi-cavity blow-mold sub-assemblies;

FIG. 12 is an isometric view of the prior art product and integrally attached gutter flash conventionally removed from known production blow-molding machines incorporating state of the art product blow-mold sub-assemblies;

FIGS. 13 through 18 are schematic partial blow-molding machine section views illustrating key points in the method step sequence which is practiced during utilization of the blow-mold sub-assemblies of the present invention;

FIGS. 19 and 20 are schematic plan views illustrating the base blow-mold sub-assembly stripper plate component of the FIGS. 1 through 7 apparatus positioned in two different successive operating conditions;

FIG. 21 is a section view taken at line 21-21 of FIG. 2209;

FIG. 22 is a section view taken at line 22-22 of FIG. 21;

FIG. 23 is a schematic diagram of one form of control system that may be utilized to obtain proper sequencing of the several bi-directional power actuators, both pneumatic and hydraulic, incorporated in the apparatus of FIGS. 1 through 7;

FIG. 24 illustrates additional construction details of the blow-mold sub-assembly shown in FIG. 5;

FIG. 25 is a schematic elevation view similar to FIG. 3 but of the interior of the blow-molding machine of FIG. 1 incorporating another embodiment of the blow-mold sub-assemblies of the present invention;

FIG. 26 is a schematic isometric view of the product single-cavity mold sub-assembly illustrated in FIG. 25 in an initial operating condition;

FIG. 27 is view similar to FIG. 26 but illustrating the alternate-embodiment of the invention blow-mold sub-assemblies in a subsequent operating condition;

FIG. 28 is a section view taken at line 28-28 of FIG. 25 in an initial operating condition;

FIG. 29 is a view similar to FIG. 28 but in a subsequent operating condition;

FIG. 30 is an enlarged view of a designated portion of FIG. 28;

FIG. 31 is an enlarged view of a designated portion of FIG. 29; and

FIG. 32 is a schematic plan view of the product blow-molded in the apparatus of FIGS. 25 through 29 with the subsequently separated gutter flash.

### DETAILED DESCRIPTION

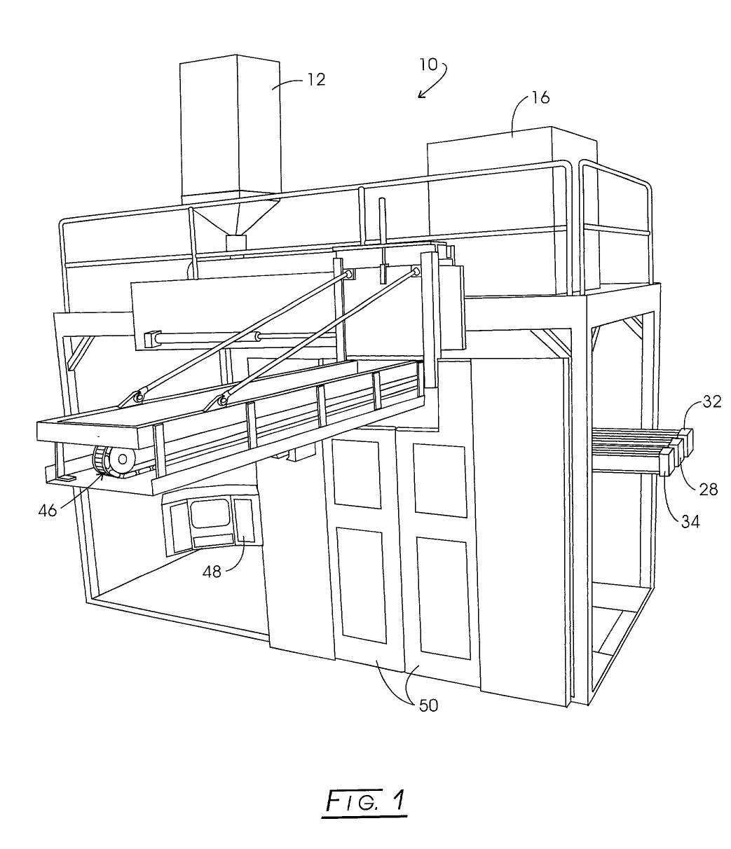

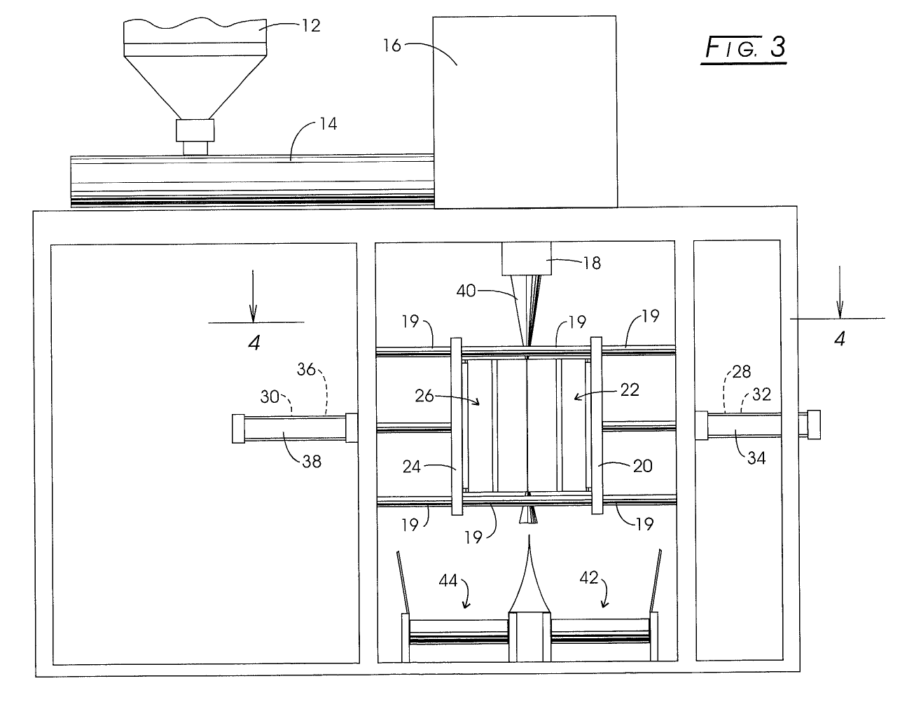

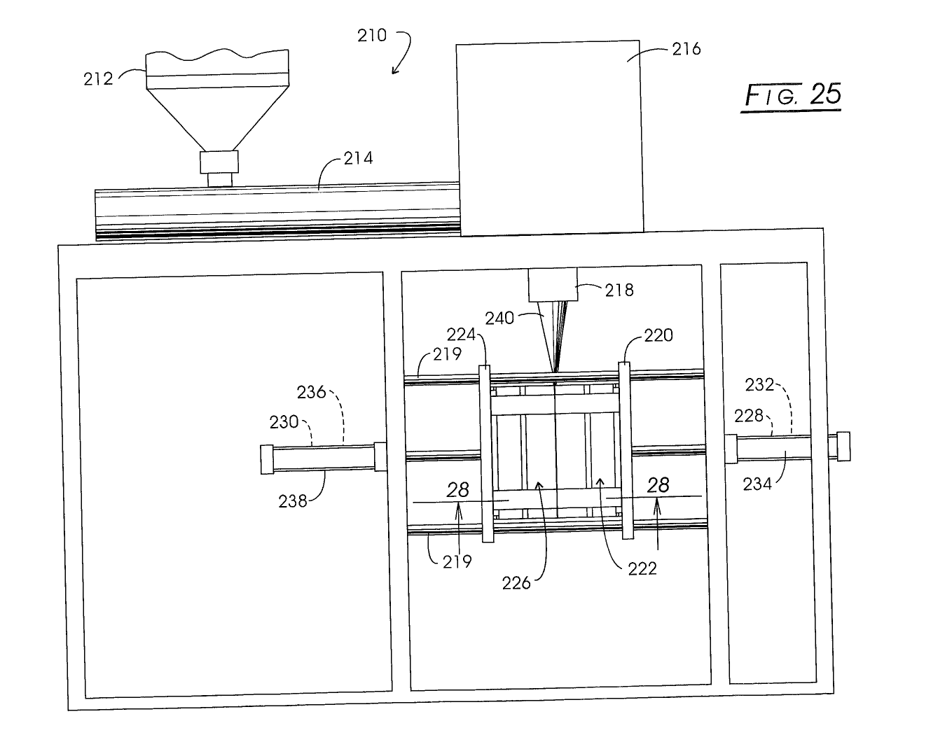

The method of the present invention involves a basic step sequence of blow-molding an extruded and heated thermoplastic resin parison contained within co-operating closed blow-mold subassemblies to form a blow-molded product with integrally attached gutter flash, separating the integrally attached gutter flash from the blow-molded product at the product mold parting-line perimeter while the product is fully restrained by the closed blow-mold sub-assemblies, and afterwards opening the closed blow-mold sub-assemblies for purposes of accomplishing removal of the product and separated gutter flash from the blow-mold apparatus. The forces applied to the gutter flash during such gutter flash separation are essentially tension forces rather than conventional near-instantaneous cutting or shear forces. One embodiment of apparatus particularly well-suited for the production of multiple units of a relatively small, blow-molded product in one complete operating cycle of a conventional industrial blow-molding machine is detailed in FIGS. 1 through 24 of the drawings. Another embodiment of the apparatus of the present invention, an embodiment generally intended for use in the production of a single unit of a relatively large, blow-molded product in one complete operating cycle of the conventional industrial blow-molding machine is detailed in FIGS. 25 through 32.

FIGS. 1 through 4 schematically illustrate a conventional industrial blow molding machine 10, such as the large-size either SE or SL Series “Sterling” blow molding system manufactured and marketed by Davis-Standard Corporation of Edison N.J., customized to include the blow-mold assemblies utilized in the practice of the present invention. Such machine generally has a throat size that ranges from 38 inches by 36 inches to 84 inches by 60 inches, and is especially well adapted to the production in each machine cycle of either a single very large blow-molded product or multiple smaller-sized blow-molded products utilizing, in either case, an extremely short production cycle time generally varying from approximately 45 to 60 seconds per cycle. Production rates for machine 10 typically varies in the range from 60 to 480 or more units of blow-molded product per hour, depending upon product dimensional size. Such machine is capable of blow-molding a variety of different thermoplastic resins including polyolefin resins and other resins such as polycarbonate, polyethylene, polyvinylchloride, and like resins that are technically-formulated for use in blow-molding applications.

Machine 10 typically includes the illustrated feedstock hopper 12, a feed screw feedstock conveyor 14, and a conventional melter-accumulator-extruder subassembly 16 with variably-controlled parison die head 18. Machine 10 also includes guideposts 19 upon which movable platens 20 and 24 reciprocate. Movable machine platen 20 carries base blow-mold sub-assembly 22 and movable machine platen 24 carries cap blow-mold sub-assembly 26. Although such base and cap blow-mold sub-assemblies have co-operating complementary product-forming cavities and generally similar constructions, their respective total function and modes of operation differ.

Machine platen 20 is powered by bi-directional rapid traverse hydraulic actuator 28 and additionally by bi-directional clamping hydraulic actuators 32 and 34; machine platen 24 is powered by bi-directional rapid traverse hydraulic actuator 30 and additionally by bi-directional clamping hydraulic actuators 36 and 38. In addition, conventional blow-molding machine 10 typically includes trimmed blow-mold product discharge conveyor 42, flash discharge conveyor 44, and may optionally also include a conventional overhead discharge conveyor 46 (see FIG. 1) normally utilized for removing conventionally formed product units with integrally attached flash from within the machine. Machine 10 typically also includes a operator's control panel or control station 48 and access doors 50 which, when opened, provide access to the interiorly-located invention blow-mold sub-assemblies 22 and 26 for installation and maintenance servicing purposes and the like.

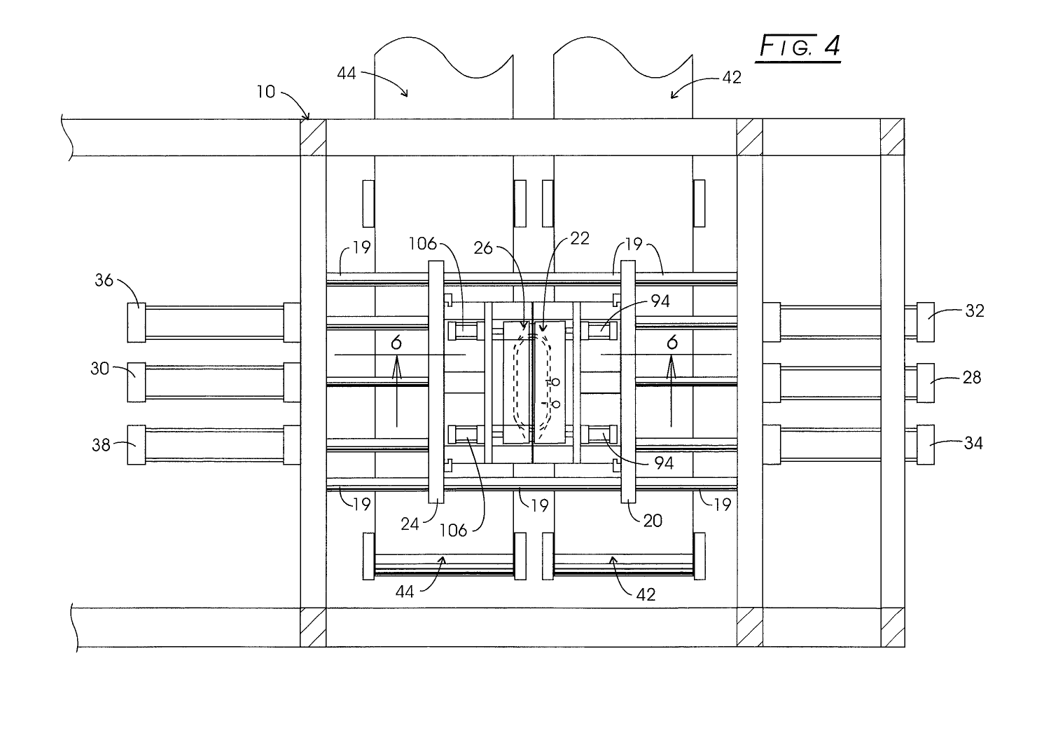

As shown in FIG. 5, blow-mold sub-assembly 22 is provided with a base plate 60 to which are rigidly attached are slotted platen mounting blocks 62 and 64, intermediate support block 66, and crash pads 68 and 70 which function to maintain a proper base blow-mold sub-assembly distance of separation from cap blow-mold sub-assembly 26 when such blow-mold sub-assemblies are positioned in an operationally closed condition with respect to each other, usually a small distance not exceeding approximately ten thousandths (0.010) of an inch and often as little as approximately one thousandth (0.001) of an inch. This separation distance may increase somewhat both when pressurized air is being injected into the interior of the parison segment constrained by the co-operating blow-mold sub-assemblies during product formation, and also after the actuators forcing the the blow-mold sub-assemblies together are relieved of internal fluid pressures prior to opening the blow-mold sub-assemblies for product and gutter flash removal purposes. Crash pad 70 has projecting tapered guide pins 72 that co-operate with crash pad tapered guide pin receptacles provided in cap blow-mold assembly 26 upon closure; crash pad element 68 has tapered guide pin receptacles 74 that co-operate with the tapered guide pins provided in cap blow-mold sub-assembly 26.

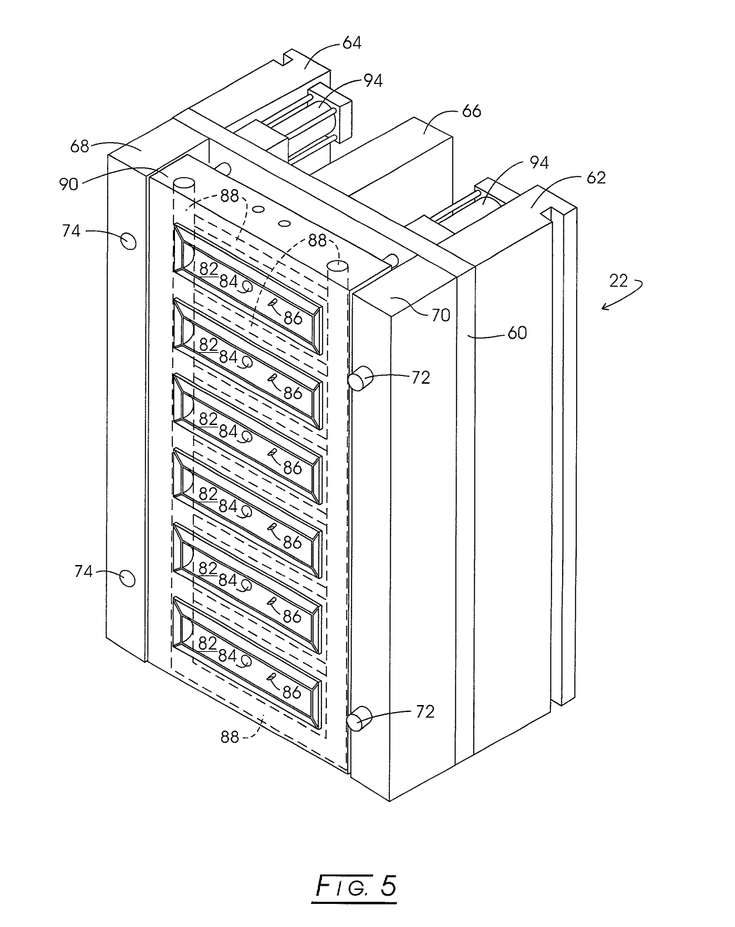

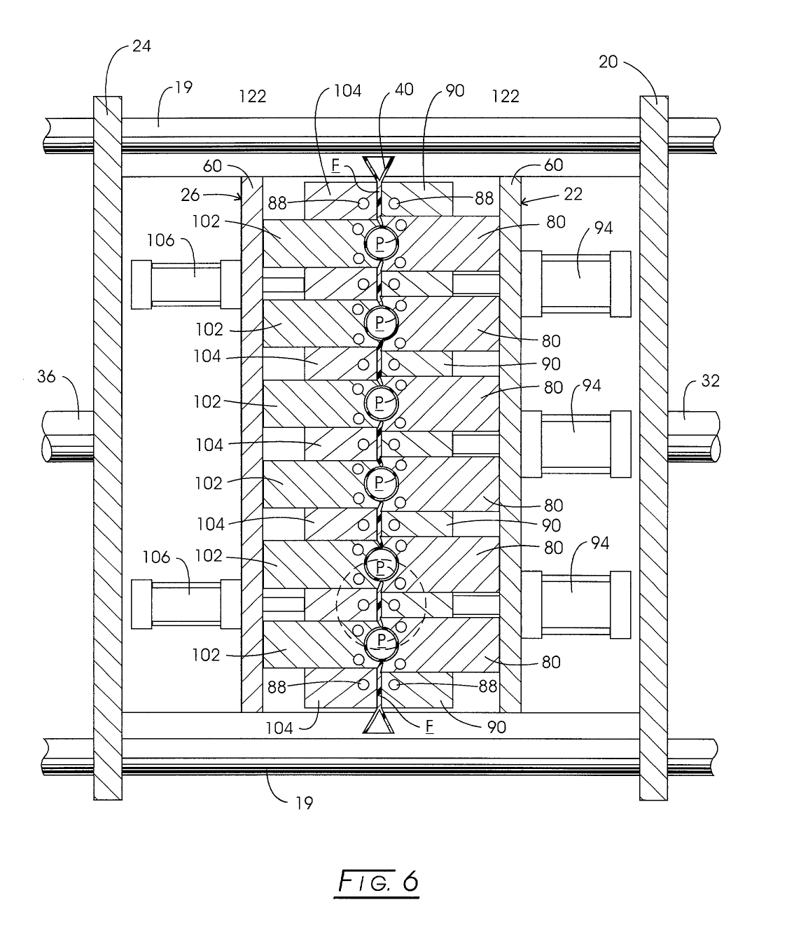

Base blow-mold sub-assembly 22 also includes multiple product molds 80 that are each rigidly mounted on base plate 60, and that each have a product cavity half 82, a pneumatically-actuated conventional bi-directional product ejector 84, and a pneumatically-actuated extendible and retractable inflation needle 86 that injects pressurized air into the interior of parison 40 to effect parison expansion. A movable gutter plate element 90 which surrounds each one of multiple product molds 80 is also included in sub-assembly 22 and such is provided with interconnected longitudinal and transverse cooling water passageways 88 that are connected to a flowing source of coolant such as cooling water. Each mold element 80 also is provided with cooling water passageways 92 that are preferably located in the region of the product mold parting line perimeter that also are, like coolant passageways 88, connected to a flowing source of coolant. In some applications the coolant may have a solidification temperature significantly lower than the solidification temperature of water, i.e. significantly lower than 32° Fahrenheit. See FIGS. 6 through 9 for further illustration of locating such coolant passageways in proximity to the product mold cavity mold parting line perimeter 112.

Gutter plate element 90 is connected to and operationally powered by banks of bi-directional hydraulic cylinders 94 positioned at opposite edge regions of the gutter plate. For clarity of illustration, additional details of construction preferred for gutter plate element 90 are shown separately in FIG. 24 of the drawings.

Referring to FIG. 24, it may be seen that gutter plate element 90 has a plurality of V-shaped, groove-like recesses or reservoirs 91 that are formed in its face and extend transversely between or from mold cavities 82. Such recesses or reservoirs accommodate excess heated parison resinous material associated with different programmed parison wall thicknesses. By having excess material flow into the reservoirs, the cooled gutter plate element 90 can contact the adjacent surface of the entire gutter flash better to ensure even and more rapid cooling thereof. Illustrated retainer pin inserts 93 are provided and installed around the periphery of gutter plate element 90 and function to lock the edges of the gutter flash (F in FIG. 12) in place and prevent gutter flash edge shifting movement during gutter flash separation from the blow-molded thermoplastic resin product. Alternatively, retainer recesses, either in the form of blind-holes or through-holes, can be substituted for retainer pin inserts.

As previously suggested, apparatus cap blow-mold sub-assembly 26 is basically constructed similarly to the construction of base blow-mold sub-assembly 22, but differs in several respects such as is particularly shown in FIGS. 6 through 9. The most notable differences are that the product molds 102 of sub-assembly 26 which co-operate with product molds 80 of sub-assembly 22 are sized differently as hereinafter described, and that the gutter plate element 104 of assembly 26 is connected to and operationally actuated by banks of bi-directional pneumatic actuators 106. In some instances or applications bi-directional hydraulic actuators may be preferred and substituted for the pneumatic bi-directional actuators. Also, and while not shown in the drawings or suggested elsewhere, other primary power sources such as electric motors combined with various mechanical linkages, devices, and the like may be substituted for components 94 and 106 and utilized as the actuators that cause movement of gutter plates 90 and 104 relative to the co-operating product molds.

The fluid pressures of actuation-causing fluids supplied to bi-directional hydraulic actuators 94 are controlled so that the resulting actuation forces are substantially greater than the forces resulting from compressible actuation-causing fluids supplied to bi-directional pneumatic actuators 106 whereby gutter plate element 90, when moved, causes gutter plate element 104 to movably yield and the compressible fluids supplied to actuators 106 to be further compressed.

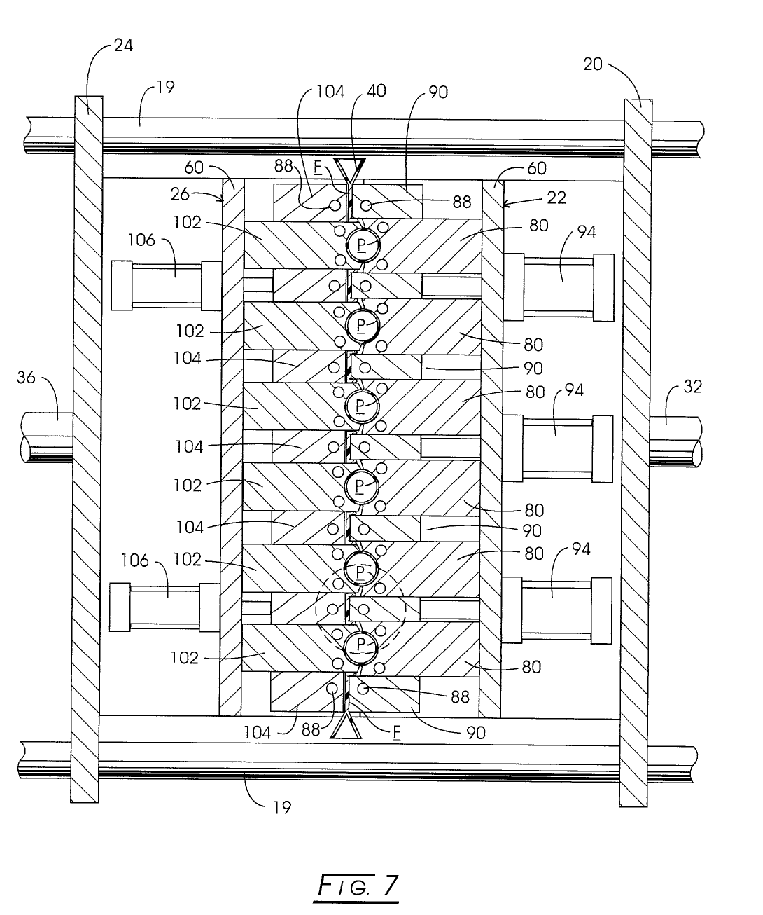

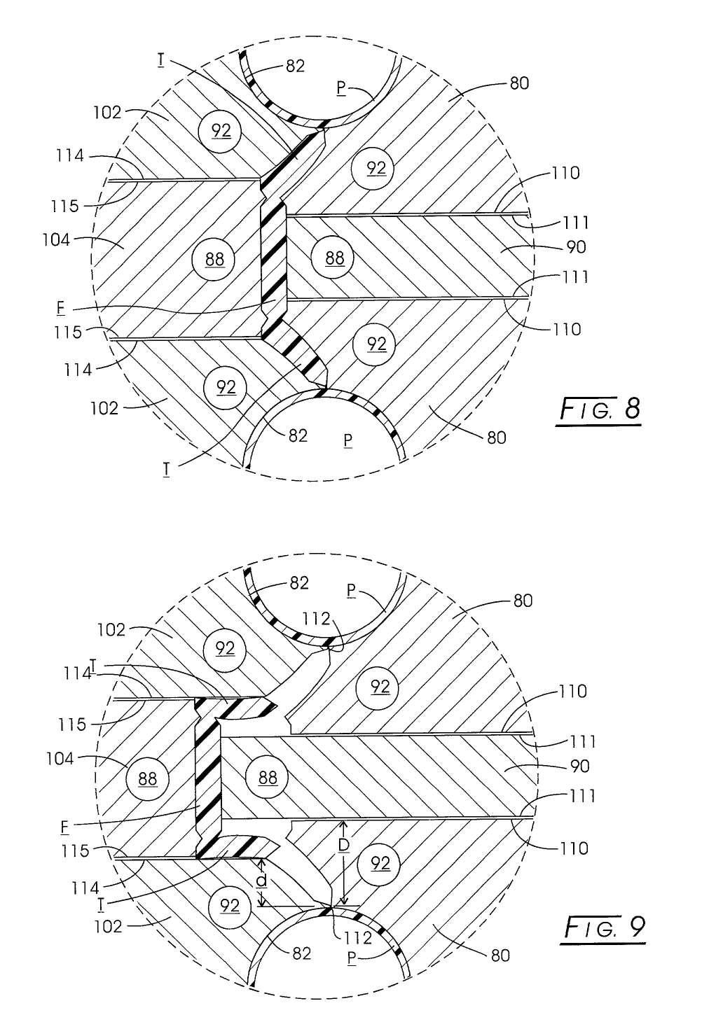

Referring to FIGS. 8 and 9, each assembly mold element 80 is constructed to have an outside wall surface 110 that is congruent with the configuration of mold parting line perimeter 112 of blow-molded product P but is uniformly spaced away from perimeter 112 by the distance D which typically is about six-tenths (0.6) of an inch. The outside wall surface 114 of assembly mold element 102, on the other hand, while congruent with the configuration of product mold parting line perimeter 112 is spaced away from the parting line perimeter uniformly by the smaller distance d which typically is approximately three-tenths (0.3) of an inch. Generally, the preferred difference between dimensions D and d is in the range of approximately one-quarter to one-half inch. Product mold parting line perimeter 112 preferably is as little as about one-thousandth (0.001) inch in width in a directions parallel to the direction of closure of blow-mold sub-assemblies 22 and 26, such width being controlled by the co-operating engagement of crash pads 68 and 70 of the two blow-mold subassemblies to additionally prevent mold assembly damage caused by rapid traverse closing of machine platens 20 and 24.

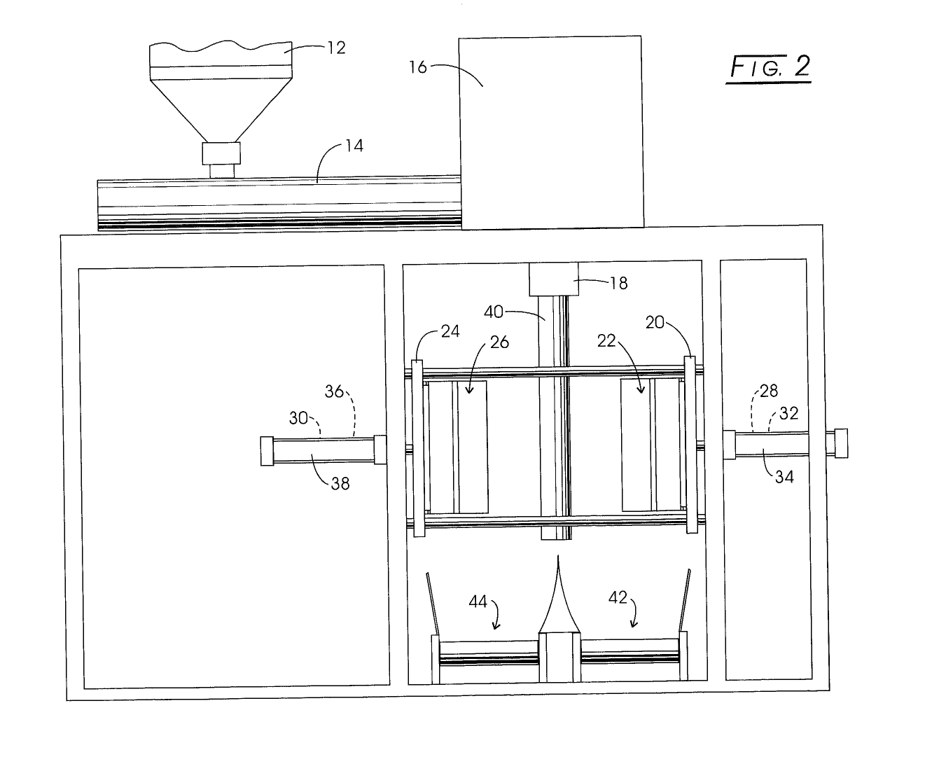

In the blow-mold sub-assembly schemes of FIGS. 2 through 9, and because the forces for separating gutter flash F from blow-molded product P are developed by actuators 94 in directions normal to the plane of product mold parting line perimeters 112, it is necessary to form transition tabs T integral with, and as a part of the gutter flash F surrounding product mold cavities 82. Basically, each formed transition tab T is tapered and is angled or curved in the direction from product mold outside wall 114 toward product mold line perimeter 112. Thus, when solidified gutter flash F is moved by the movement of gutter plate element 90 from the condition shown in FIG. 8 to the condition illustrated in FIG. 9, each integral transition tab is separated from product P along product mold line perimeter 112 by tension forces and dragged upwardly and into frictional contact with product mold outside wall 114 as gutter plate 90 advances and gutter plate 104 retracts as shown in FIG. 9. To facilitate such placement of transition tab T upon product mold outside wall 114, transition tab T is advantageously segmented along the product mold parting line perimeter 112 by appropriately positioned multiple transition tab slits S (see FIG. 10). Generally, a transition tab slit S is provided at each substantial change in perimeter direction, such as at a perimeter corner or substantial linear departure, and at uniformly spaced-apart positions throughout each product mold-line perimeter segment of substantial curvature. Such slits S can be conveniently formed by providing spaced-apart, thin transition tab transverse divider or partition elements in the transition tab zones and integral with either base blow-mold sub-assembly product molds 80 or cap blow-mold sub-assembly product molds 102 at the desired transition tab slit locations. Slits S function to allow gutter flash F to fold easily during movement in the mold volume or zone between mold outer wall surfaces 110 and 114 as mentioned above.

FIGS. 10 and 11 respectively illustrate the gutter flash F formed within blow-mold subassemblies 22 and 26 following separation from blow-molded product P and the separated product P following their ejection from such blow-mold sub-assemblies. Gutter flash F is freed from contact with mold outside wall 114 by the action of bi-directional pneumatic/hydraulic actuators 106. Each unit of product P is freed from retention in a mold cavity 82 by proper sequential actuation of bi-directional pneumatic product ejectors 84.

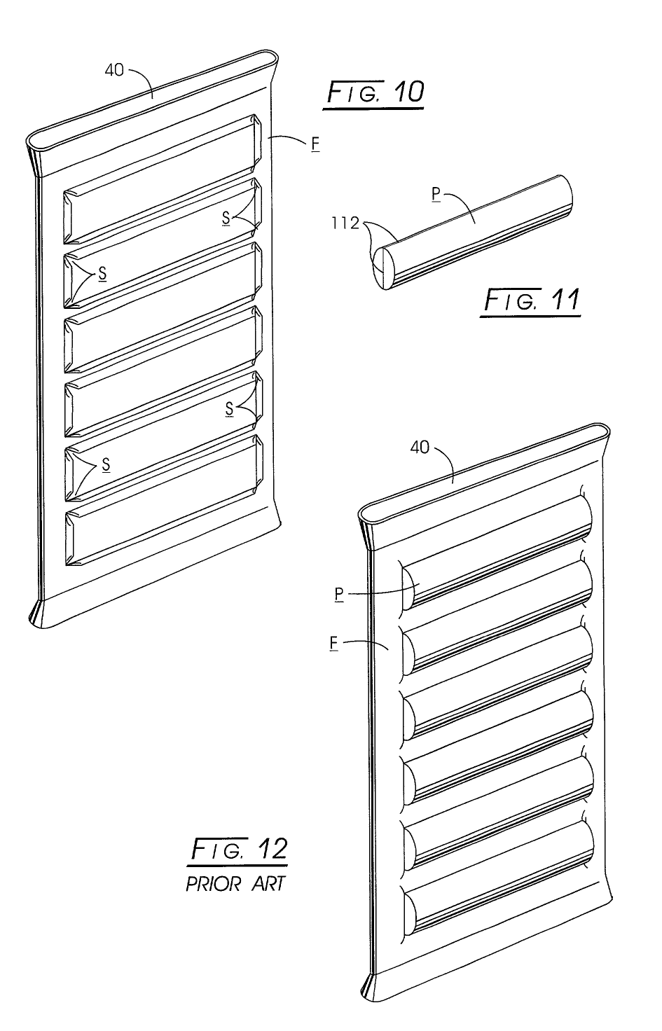

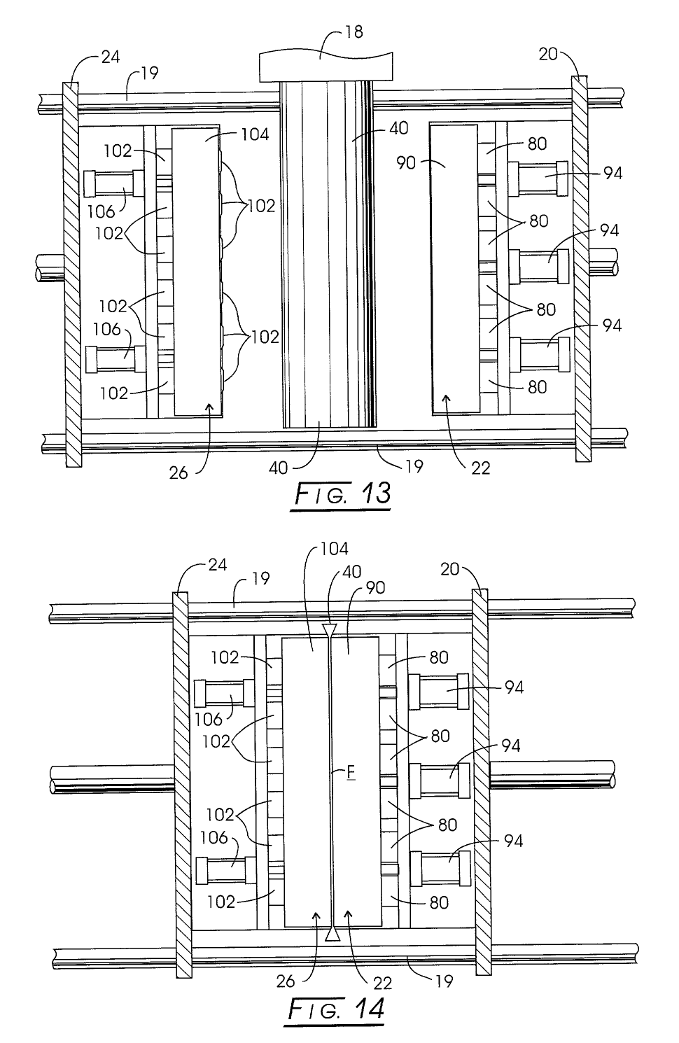

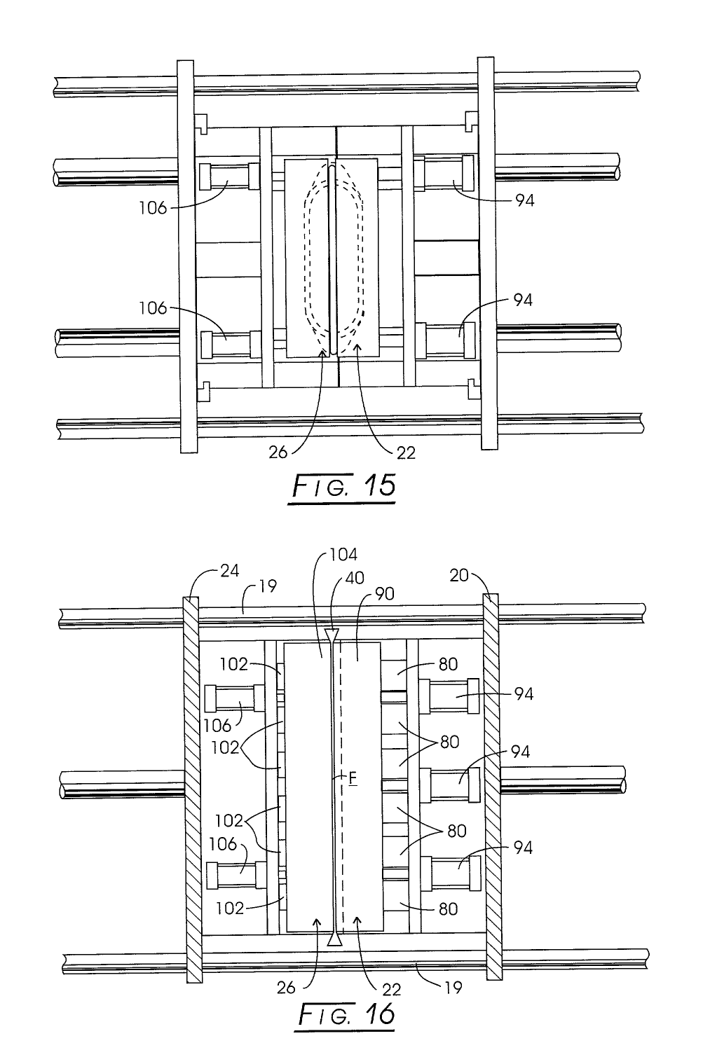

FIGS. 13 through 18 schematically illustrate the sequence of key steps that are accomplished during a complete production machine cycle utilizing utilizing blow-mold sub-assemblies 22 and 26. FIG. 13 illustrates such blow-mold sub-assemblies in their cycle initial or fully-open condition and extruded and heated thermoplastic resin parison 40. FIG. 14 is similar to FIG. 13 but shows the blow-mold sub-assemblies in their subsequent operationally-closed condition with parison 40 contained therebetween. FIG. 15 is a plan view illustrating gutter plate element 90 moved by bi-directional hydraulic actuators 94 to effect complete separation of the contained gutter flash from the fully-restrained blow-molded product to which it was integrally attached; FIG. 16 corresponds to FIG. 15 but is an elevation view of the same apparatus in the gutter flash fully-separated condition. Bi-directional pneumatic actuators 106 are normally activated at this stage of the production cycle but because they are operated with a compressible fluid they readily yield to the gutter plate displacement forces generated by hydraulic actuators 94.

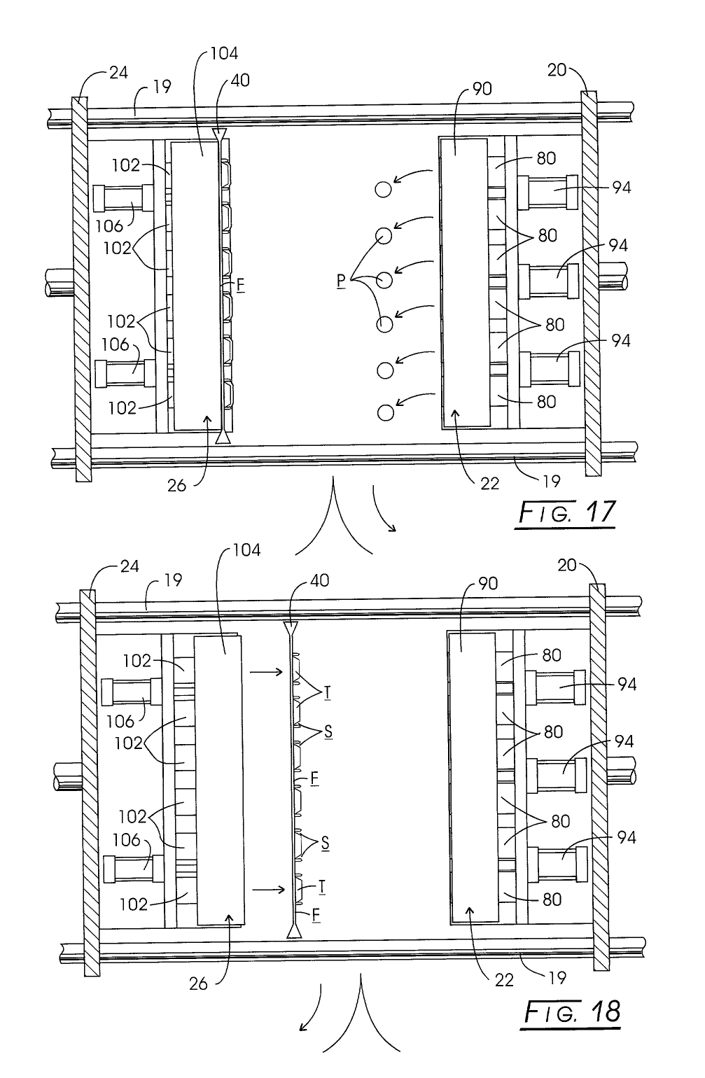

FIG. 17 illustrates blow-mold sub-assemblies 22 and 26 subsequently returned to their fully-open condition and with separated gutter flash F retained upon the outside walls of the product molds 102 included in cap blow-mold sub-assembly 26. With blow-mold 22 in its FIG. 17 position, product ejectors 84 are actuated to cause contained units of product P to be ejected from their respective mold cavities 82 so that they will fall onto product conveyor 42 for removal from within blow-mold machine 10.

FIG. 18 illustrates gutter flash F after it has been separated from blow-mold sub-assembly 26 by the operation of pneumatic actuators 106. Such gutter flash then drops to the discharge conveyor 44 also for removal from within blow-mold machine 10. The next production cycles can then be commenced by causing additional thermoplastic resin parison material to descend sufficiently from parison die head 18 so that blow-mold sub-assemblies 22 and 26 can then be moved to their fully-closed and clamped condition by operation of machine bi-directional hydraulic actuators 28 through 38.

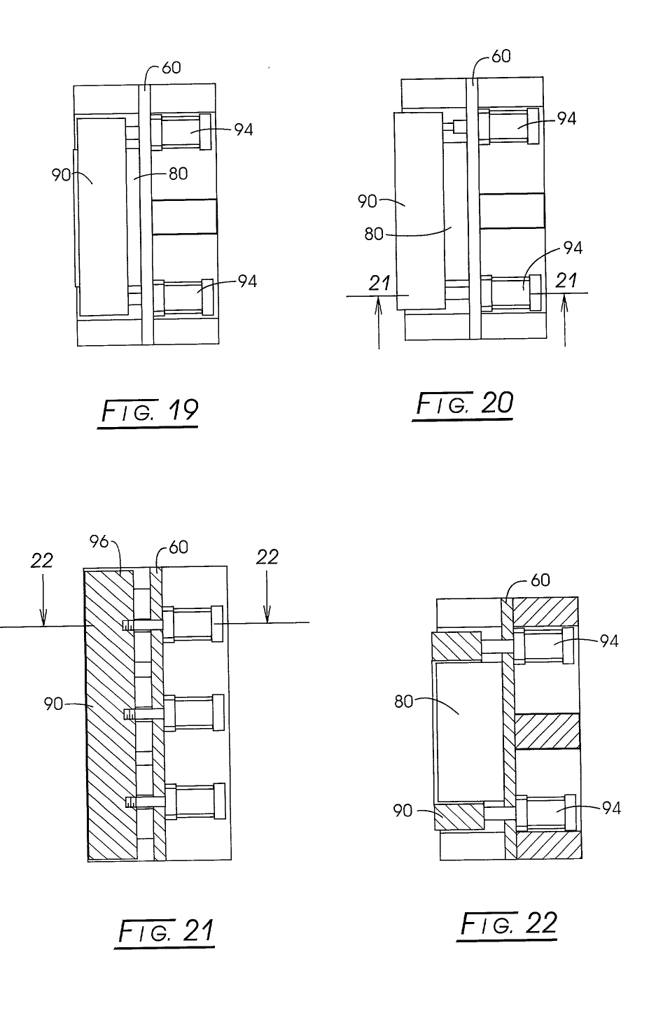

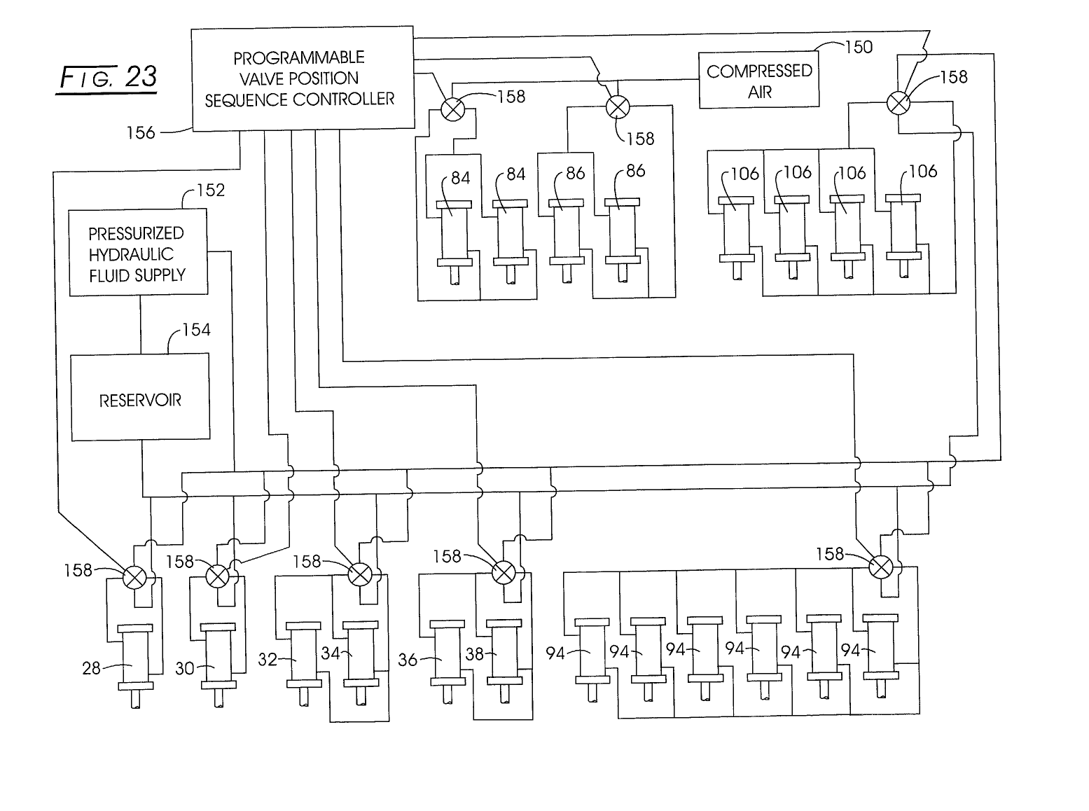

FIGS. 19 through 22 illustrate some additional construction details that are preferred for incorporation into blow-mold sub-assemblies 22 and 26. Plan views 19 and 20 respectively illustrate gutter plate element 90 in its fully-retracted and fully-extended operating cycle conditions. FIGS. 21 and 22 are elevation and plan section views respectively corresponding to the FIG. 19 and FIG. 20 operating conditions.

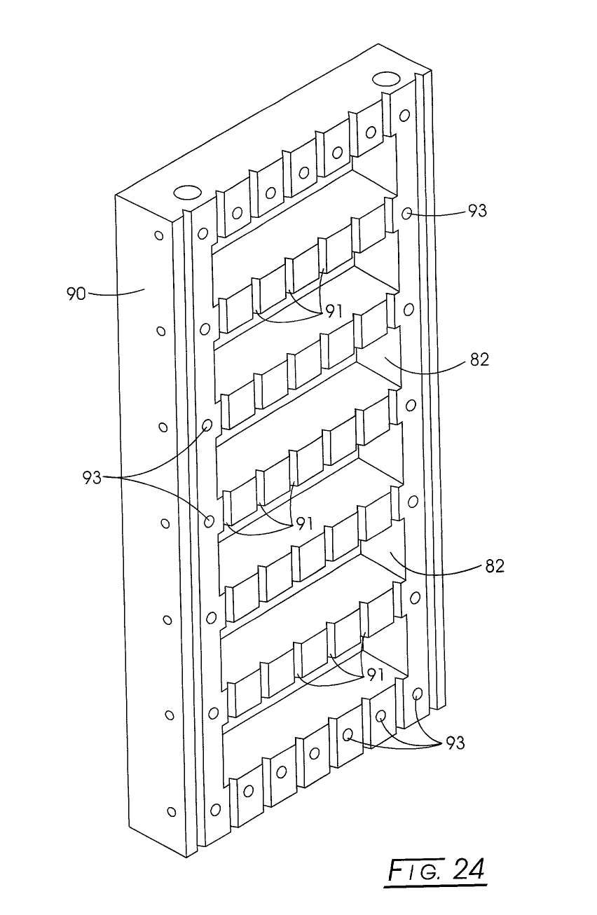

FIG. 23 schematically illustrates one type of control system that may be utilized in connection with combined blow-mold sub-assemblies 22 and 26 to obtain proper sequencing of the different incorporated pneumatic/hydraulic bi-directional actuators in order to carry out the basic product de-flashing steps of my method invention for different specific-product applications. Such control system preferably includes a compressed air source 150, a pressurized hydraulic fluid supply 152 with fluid reservoir 154, and a conventional programmable valve position sequence controller 156 that sequentially activates each of the included conventional 4-way fluid valves 158 to its different valve operating positions and thereby achieve full extension or full retraction of each of the specifically numbered bi-directional actuators connected thereto at the proper time in each production cycle of blow-molding machine 10.

The basic sequence of steps for operating blow-molding machine or system 10, including blow-mold assemblies 22 and 26, for a complete machine production cycle are as follows:

1. Activate machine 10.

2. Retract platens 20 and 24 to fully-separate (open) blow-mold assemblies 22 and 26 (machine function).

3. Cause heated tubular thermoplastic resin parison 40 to descend from die-head 18 to lower edges of assemblies 22 and 26 (machine function).

4. Rapid advance platens 20 and 24 sufficient to engage all crash pads 68 and 70 and thereby fully close blow-mold assemblies 22 and 26 by actuating rapid traverse hydraulic actuators 28 and 30 (machine function).

5. Clamp blow-mold assemblies 22 and 26 together by simultaneously activating hydraulic actuators 32, 34, 36, and 38 (machine function).

6. Insert inflation needles 86 into the descended parison contained within mold assemblies 22 and 26.

7. Inject compressed air into contained parison thereby expanding heated parison thermoplastic resin into complete contact with the product cavities 82 of blow-mold sub-assemblies 22 and 26 (machine function) and form thermoplastic resin product P.

8. Activate bi-directional hydraulic actuators 94 and bi-directional pneumatic actuators 106 each to a pressure level that causes gutter plates 90 and 104 to engage and fully contact the surfaces of gutter flash F and to flow any excess parison material into the gutter plate excess material reservoirs 91, whereupon accelerated cooling of parison gutter flash material captured between gutter plates 90 and 104 commences.

9. Activate bi-directional hydraulic actuators 94 to move gutter plates 90 and 104 along straight lines thereby separating gutter flash F from blow-molded product P at the product mold parting line perimeter using tension forces.

10. Relieve de-flashing fluid pressure imposed on fluid actuators 94.

11. Reverse the actuation direction of clamping bi-directional hydraulic actuators 32, 34, 36, and 38 (machine function).

12. Reverse the actuation direction of bi-directional rapid traverse hydraulic actuator 28 to partially separate and open blow-mold assemblies 22 and 26.

13. Reverse the actuation direction of bi-directional rapid traverse hydraulic actuator 30 to fully separate and open blow-mold assemblies 22 and 26.

14. Actuate product ejectors 84 to release product units P from blow-mold cavities 82 for free-fall to the machine product removal conveyor 42.

15. Actuate pneumatic bi-directional actuators 106 to separate gutter flash F from engagement with the product molds 102 of blow-mold assembly 26 for free-fall to the machine product removal conveyor 44.

16. Repeat steps 3 through 15 to end of machine production run.

17. Deactivate machine 10.

The time required for completing the sequence of steps 3 through 16 is typically in the range of 45 to 120 seconds for industrial blow-molding systems of the type specifically identified in connection with machine 10.

In instances wherein very large blow-molding machine throat dimensions are involved, and sometimes in blow-molding applications wherein the product being blow-molded has a relatively long major dimension, it may prove advantageous to utilize an alternate form of apparatus blow-mold assembly to obtain desired separation of integrally attached gutter flash from the blow-molded product along the product's mold parting-line perimeter. An alternate form of the invention blow-mold sub-assemblies intended for this purpose are schematically illustrated and detailed in FIGS. 25 through 32 of the drawings, and are shown installed in a conventional industrial blow-molding system 210 similar to blow-molding machine 10.

Machine 210 typically includes the illustrated feedstock hopper 212, a feed screw feedstock conveyor 214, and a conventional melter-accumulator-extruder subassembly 216 with variably-controlled parison die head 218. Machine 210 also includes guideposts 219 upon which movable platens 220 and 224 reciprocate. Movable machine platen 220 carries base blow-mold sub-assembly 222 and movable machine platen 224 carries cap blow-mold sub-assembly 226. Although such base and cap blow-mold sub-assemblies have co-operating complementary product molds 280 and 302 with product-forming cavities 282 and with generally similar constructions, their respective total function and modes of operation differ. For instance, only base blow-mold sub-assembly 222 is provided with a gutter plate element and with co-operating bi-directional gutter plate actuators.

Machine platen 220 is powered by bi-directional rapid traverse hydraulic actuator 228 and additionally by bi-directional clamping hydraulic actuators 232 and 234; machine platen 224 is powered by bi-directional rapid traverse hydraulic actuator 230 and additionally by bi-directional clamping hydraulic actuators 236 and 238.

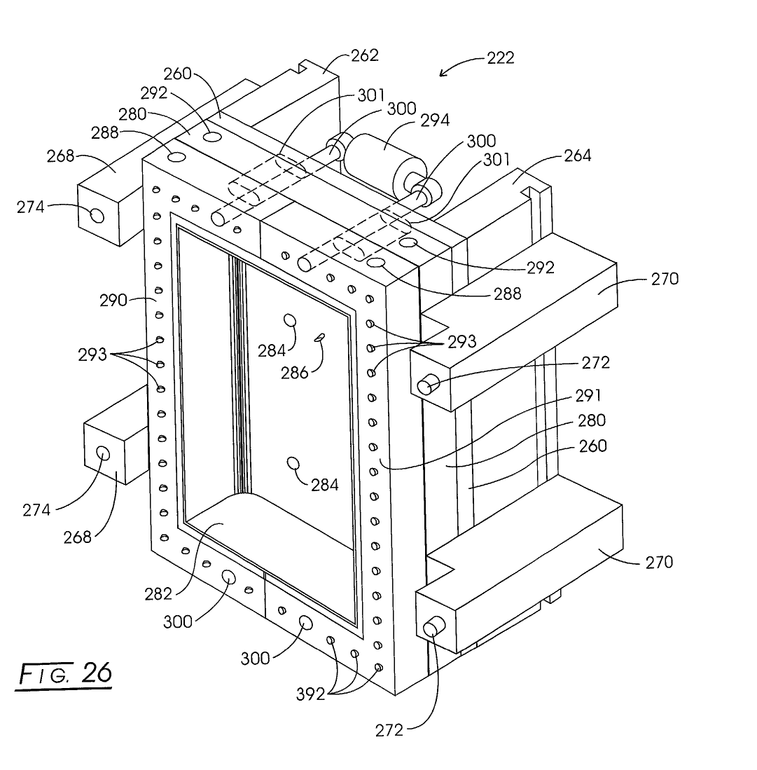

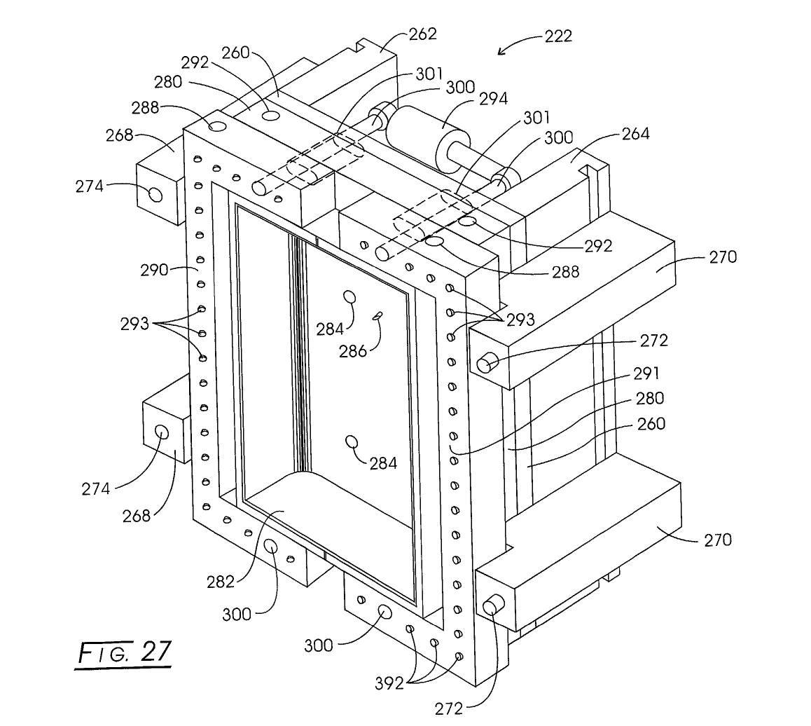

As shown in FIGS. 26 and 27, blow-mold sub-assembly 222 is provided with a base plate 260 to which are rigidly attached slotted platen mounting blocks 262 and 264 and crash pads 268 and 270. Such crash pads function to maintain a proper base blow-mold sub-assembly distance of separation from cap blow-mold sub-assembly 226 when such blow-mold sub-assemblies are positioned in an operationally-closed condition with respect to each other, usually approximately one thousandth (0.001) of an inch. Crash pads 270 have projecting tapered guide pins 272 that cooperate with respective crash pad tapered guide pin receptacles provided in cap blow-mold assembly 226 upon closure; crash pad elements 268 have tapered guide pin receptacles 274 that co-operate with respective tapered guide pins provided in cap blow-mold sub-assembly 226.

Base blow-mold sub-assembly 222 also includes a single-cavity product mold 280 that is rigidly mounted on base plate 260 and that has an interior product cavity half 282, pneumatically-actuated conventional bi-directional product ejectors 284, and a pneumatically-actuated extendible and retractable inflation needle 286 that injects pressurized air into the interior of parison 240 to effect parison expansion. An articulated gutter plate comprised of generally U-shaped gutter plate elements 290 and 291 that surround product cavity 282 of product mold 280 is also included in sub-assembly 222 and such gutter plate elements are each provided with cooling water passageways 288 that are connected to a flowing source of cooling water. Product mold element 280 also is provided with cooling water passageways 292 (see FIGS. 26 and 27) that are preferably located in the region of the product mold parting line perimeter that also are, like coolant passageways 288, connected to a flowing source of cooling water. See FIGS. 30 and 31 for further illustration of the manner of locating such coolant passageways.

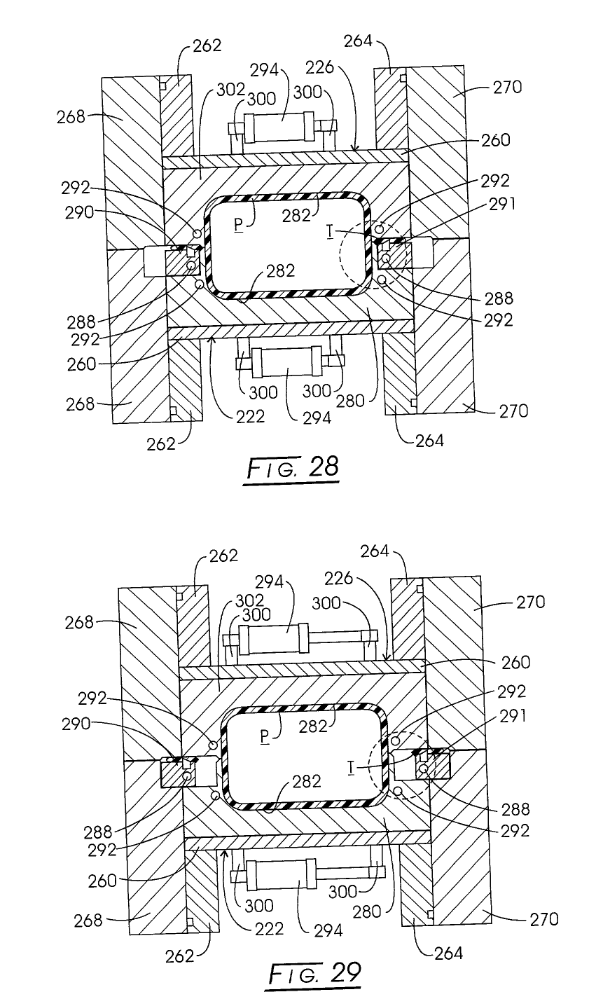

Gutter plate elements 290 and 291 are each connected to, and operationally powered by, dual, bi-directional hydraulic actuators 294. (See FIGS. 28 and 29). Rigid rod-like couplings 300 are utilized to connect each rod end of a dual actuator to a respective end of a gutter plate element 290 and 291. Couplings 300 co-operate with elongated guide slots 301 provided in sub-assembly product mold 280, and essentially reciprocate in response to actuation of double-acting bi-directional actuators 294. Such actuators each function in a conventional manner whereby their rods are either simultaneously extended or simultaneously retracted.

Additionally, each one of gutter plate elements 290 and 291 are provided with flash edge retainer elements 293 (either short protrusion inserts or retainer recesses) that embed or become embedded in the parison thermoplastic resin material captured between the faces of the gutter plate elements when mold-assemblies 222 and 226 become clamped to thereby enhance the transmission of tension forces originating with hydraulic actuators 294 in effecting gutter flash separation. Since the forces generated by actuators 294 are in planes that are parallel to the plane of the product mold parting line perimeter it is not necessary to provide, as in FIGS. 8 and 9, an angled or curved intermold transition zone for forming the tapered transition tab T feature that is included and integrally attached to and retained as a part of gutter flash F.

The basic sequence of steps for operating blow-molding machine or system 210, including blow-mold sub-assemblies 222 and 226, for a complete machine production cycle are as follows:

1. Activate machine 210.

2. Retract platens 220 and 224 to fully-separate (open) blow-mold sub-assemblies 222 and 226 (machine function).

3. Cause heated tubular thermoplastic resin parison 240 to descend from die-head 218 to lower edges of blow-mold sub-assemblies 222 and 226 (machine function).

4. Rapid advance platens 220 and 224 sufficient to engage all crash pads 268 and 270 and thereby fully close blow-mold sub-assemblies 222 and 226 by actuating rapid traverse hydraulic actuators 228 and 230 (machine function).

5. Clamp blow-mold sub-assemblies 222 and 226 together by simultaneously activating hydraulic actuators 232, 234, 236, and 238 (machine function).

6. Insert inflation needle 286 into the descended parison contained within the product cavities 282 of blow-mold sub-assemblies 222 and 226.

7. Inject compressed air into contained parison through needle 286 thereby expanding heated parison thermoplastic resin contained within blow-mold sub-assemblies into complete contact with the product cavities 282 of such blow-mold sub-assemblies (machine function).

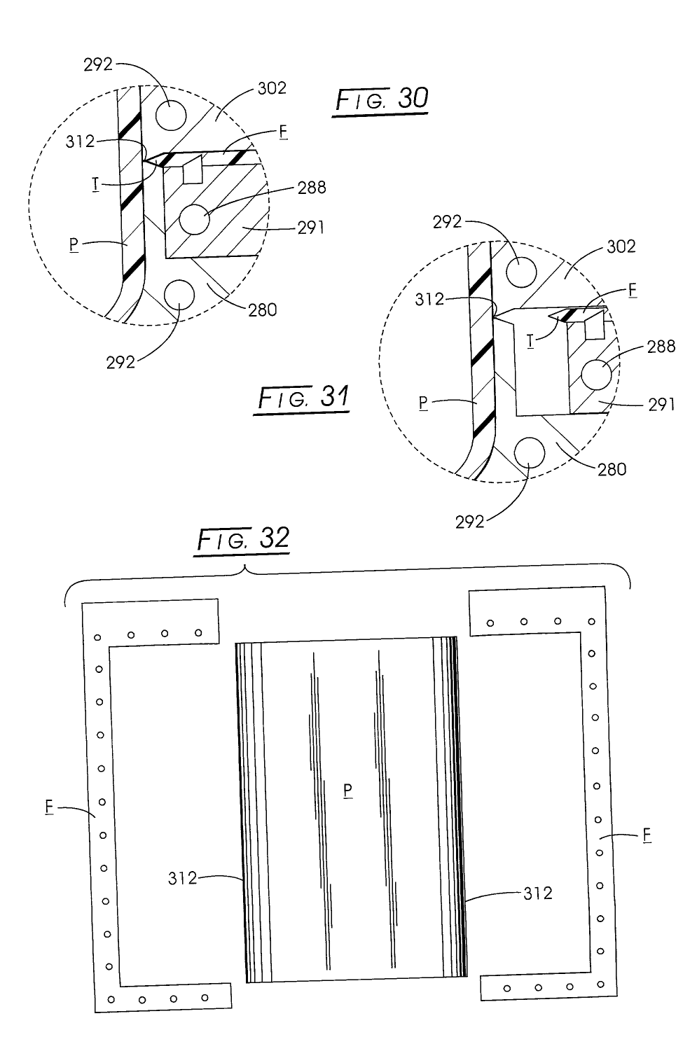

8. Activate dual, bi-directional hydraulic actuators 294 to linearly move gutter plate elements 290 and 291 relative to and away from product mold 280 thereby separating gutter flash F from blow-molded product P along the product mold parting line perimeter.312 by application of tension forces. See FIG. 32.

9. Reverse the actuation direction of clamping bi-directional hydraulic actuators 232, 234, 236, and 238 (machine function).

10. Reverse the actuation direction of bi-directional rapid traverse hydraulic actuators 228 and 230 to fully separate and fully open blow-mold assemblies 222 and 226.

11. Reverse bi-directional hydraulic actuators 294 and 298 to return gutter plate elements 290 and 291 to their initial position.

12. Actuate product ejectors 284 to eject product P and its partially integrally attached gutter flash F from retention within blow-mold assemblies 222 and 226 for removal from blow-molding machine 210.

13. Remove the product P with partially attached gutter flash F from within machine (machine function).

14. Repeat steps 3 through 13 to the end of the production run of machine 210.

15. Deactivate machine 210.

FIG. 30 schematically illustrates the combined product P and partially attached (separated) gutter flash F that are removed from blow-molding machine 210 following each cycle of machine operation. FIG. 31 shows the gutter flash F separated from blow-molded product P.

Various changes may be made to the relative sizes, shapes, and materials of construction detailed above in connection with FIGS. 1 through 32 without departing from the intent, meaning, or scope of the claims which follow.

I claim as my invention:

1. In a method of producing a blow-molded thermoplastic resin product that is contained within operationally-closed co-operating blow-mold sub-assemblies which form the product with a product mold parting line perimeter and with gutter flash integrally attached to the product at the product mold parting line perimeter, the step of separating the integrally attached gutter flash from the product at the product mold parting line perimeter while restraining the product within the operationally-closed co-operating blow-mold sub-assemblies.

2. The method invention defined by claim 1, and wherein said step of separating the integrally attached gutter flash from the product is accomplished by applying tension forces to the integrally attached gutter flash which pull the gutter flash away from the product at the product mold parting line perimeter.

3. The method invention defined by claim 1, and including a cooling step wherein the operationally-closed co-operating blow-mold sub-assemblies are each conduction-cooled by a liquid coolant in blow-mold sub-assembly regions adjacent the product and in proximity to the product mold parting line perimeter prior to said step of separating the integrally attached gutter flash from the product at the product mold parting line perimeter.

4. The method invention defined by claim 3, and wherein in said cooling step the operationally-closed co-operating blow-mold sub-assemblies are also additionally conduction-cooled by a liquid coolant in blow-mold sub-assembly regions adjacent the gutter flash prior to and during said step of separating the integrally attached gutter flash from the product at the product mold parting line perimeter.

5. The method invention defined by claim 3, and wherein said cooling step utilizes a liquid coolant having a solidification temperature that is significantly lower than the solidification temperature of water.

6. The method invention defined by claim 4, and wherein said cooling step utilizes a liquid coolant having a solidification temperature that is significantly lower than the solidification temperature of water.

7. In a method of producing a blow-molded thermoplastic resin product in blow-mold apparatus having co-operating blow-mold sub-assemblies which are each provided with a complementary product mold cavity, the steps of.
operationally-closing the blow-mold sub-assemblies with respect to each other and with a thermoplastic resin parison captured between the blow-mold sub-assemblies;
injecting a pressurized gas into the interior of said captured thermoplastic resin parison thereby forcing said thermoplastic resin parison into contact with product-defining surfaces of the blow-mold sub-assembly complementary product mold cavities to form a blow-molded thermoplastic resin product having a product mold parting line perimeter and having a gutter flash integrally attached to the product at said product mold parting line perimeter;
separating said integrally attached gutter flash from said blow-molded thermoplastic resin product at said product mold parting line perimeter while said product is restrained within said operationally-closed blow-mold sub-assemblies; and
opening said operationally-closed blow-mold sub-assemblies with respect to each other and effecting sequential removal of the product and of the separated gutter flash from the blow-molding apparatus and blow-mold sub-assemblies,
said integrally attached gutter flash being separated from said blow-molded thermoplastic resin product at said product mold parting line perimeter by the application of tension forces to said integrally attached gutter flash at gutter flash regions adjacent said formed blow-molded product mold parting line perimeter.

8. In a method of producing a blow-molded thermoplastic resin product in co-operating base and cap blow-mold sub-assemblies which each have a product mold and a relatively movable gutter plate that surrounds the product mold, the step sequence of:
operationally closing said co-operating the base and cap blow-mold sub-assemblies with their product molds in fixed positions relative to each other and with a thermoplastic resin parison captured between the base and cap blow-mold sub-assemblies;
injecting pressurized gas into the interior of the thermoplastic resin parison without causing movement of the base and cap blow-mold sub-assembly product molds relative to each other to thereby form a blow-molded thermoplastic resin product;
moving a least one of the base and cap blow-mold sub-assembly gutter plates relative to the base and cap blow-mold sub-assembly product molds to forcibly clamp portions of the captured thermoplastic resin parison between the gutter plates;
separating said integrally attached gutter flash from said blow-molded thermoplastic resin product at said product mold parting line perimeter by causing movement of the gutter plates relative to the base and cap blow-mold subassembly product molds while the product is restrained within the operationally-closed blow-mold sub-assemblies; and.
afterwards opening said operationally-closed blow-mold sub-assemblies with respect to each other and effecting sequential removal of the product and of the separated gutter flash from the blow-molding apparatus and blow-mold sub-assemblies.

9. In a method of producing a blow-molded thermoplastic resin product in co-operating base and cap blow-mold sub-assemblies which each have a liquid-cooled product mold and a relatively movable liquid-cooled gutter plate that surrounds the product mold, the step sequence of:
operationally closing said co-operating the base and cap blow-mold sub-assemblies with their product molds in fixed positions relative to each other and with a thermoplastic resin parison captured between the base and cap blow-mold sub-assemblies;
injecting pressurized gas into the interior of the thermoplastic resin parison without causing movement of the base and cap blow-mold sub-assembly product molds relative to each other to thereby form a blow-molded thermoplastic resin product;
moving at least one of the base and cap blow-mold sub-assembly liquid-cooled gutter plates relative to the base and cap blow-mold sub-assembly liquid-cooled product molds to forcibly clamp portions of the captured thermoplastic resin parison between the base and cap blow-mold sub-assembly liquid-cooled gutter plates and thereby form, and accelerate the cooling of, portions of the clamped thermoplastic resin parison as integrally attached gutter flash;
separating said integrally attached gutter flash from said blow-molded thermoplastic resin product at said product mold parting line perimeter by causing movement of the gutter plates relative to the base and cap blow-mold subassembly product molds while the product is restrained within the operationally-closed blow-mold sub-assemblies; and.
afterwards opening said operationally-closed blow-mold sub-assemblies with respect to each other and effecting sequential removal of the product and of the separated gutter flash from the blow-molding apparatus and blow-mold sub-assemblies.

10. In a method of producing a blow-molded thermoplastic resin product in co-operating base and cap blow-mold sub-assemblies which each have a product mold and a movable gutter plate surrounding the product mold, and which each function to form the blow-molded thermoplastic resin product with a blow-mold parting line perimeter, with a gutter flash tapered transition tab integrally attached to the blow-molded product along the product blow-mold parting line perimeter, and with non-tapered gutter flash integrally attached to the gutter flash tapered transition tab, the steps of:
operationally closing said co-operating the base and cap blow-mold sub-assemblies in fixed positions relative to each other and with a thermoplastic resin parison captured between the base and cap blow-mold sub-assemblies;
injecting pressurized gas into the interior of the thermoplastic resin parison to thereby form the blow-molded thermoplastic resin product with an integrally attached gutter flash tapered transition tab;
moving the base and cap blow-mold sub-assembly gutter plates relative to each other to forcibly clamp portions of the captured thermoplastic resin parison between the base and cap blow-mold sub-assembly gutter plates to thereby form, and accelerate the cooling of, portions of the clamped thermoplastic resin parison into integrally attached non-tapered gutter flash;
separating the gutter flash tapered transition tab and integrally attached gutter flash from the blow-molded thermoplastic resin product at the product mold parting line perimeter and moving the separated gutter flash transition tab and integrally attached gutter flash into frictional engagement with the exterior wall of the cap blow-mold sub-assembly product mold by causing movement of the gutter plates relative to the base and cap blow-mold subassembly product molds while the product is restrained within the operationally-closed blow-mold subassemblies and to thereby; and.
afterwards opening the operationally-closed blow-mold sub-assemblies with respect to each other and effecting sequential removal of the product and of the separated gutter flash transition tab and integrally attached gutter flash from the blow-mold sub-assemblies.

11. Apparatus for installation in a blow-molding machine and for producing a blow-molded thermoplastic resin product, comprising:
a base blow-mold sub-assembly having at least one product mold with a product cavity defined in-part by a product mold parting line perimeter, and having a movable gutter plate that is moved linearly relative to said base blow-mold sub-assembly product mold and that has an opening larger than, congruent with, and surrounding each said base blow-mold sub-assembly product mold cavity mold parting line perimeter;
a cap blow-mold sub-assembly co-operating with said base blow-mold assembly, having at least one product mold with a product cavity that is complementary to said base blow-mold sub-assembly product mold cavity and that is defined in part by a product mold parting line perimeter corresponding to said base blow-mold sub-assembly product mold cavity mold parting line perimeter, and having a movable gutter plate that is moved in a straight line relative to said cap blow-mold sub-assembly product mold and that has an opening larger than, congruent with, and surrounding each said cap blow-mold sub-assembly product mold cavity mold parting line perimeter; and
a first bi-directional actuator that is carried by said base blow-mold sub-assembly, that is connected to said base blow-mold sub-assembly movable gutter plate, and that is actuated to cause straight-line movement of said base blow-mold sub-assembly gutter plate relative to said base blow-mold sub-assembly product mold and straight-line movement of said cap blow-mold sub-assembly movable gutter plate relative to said cap blow-mold sub-assembly product mold to thereby separate integrally attached gutter flash from the blow-molded thermoplastic resin product at each said base blow-mold sub-assembly product mold cavity parting line perimeter.

12. The blow-molding machine apparatus invention defined by claim 11, and further comprising a second bi-directional actuator that is carried by said cap blow-mold sub-assembly, that is connected to said cap blow-mold sub-assembly movable gutter plate, and that is actuated to cause straight-line movement of said cap blow-mold sub-assembly pivoted gutter plate relative to said cap blow-mold sub-assembly product mold to thereby remove separated gutter flash from frictional contact with said cap blow-mold sub-assembly product mold.

13. The blow-molding machine apparatus invention defined by claim 12, and wherein actuation of said first bi-directional actuator to cause straight-line movement of said base blow-mold sub-assembly movable gutter plate to effect gutter flash separation from blow-molded thermoplastic resin product also causes straight-line movement of said cap blow-mold sub-assembly movable gutter plate against forces originated by said second bi-directional actuator.

14. The blow-molding machine apparatus invention defined by claim 11, and further comprising multiple first bi-directional actuators that are each carried by said base blow-mold subassembly, that are each connected to said base blow-mold sub-assembly movable gutter plate, and that are each actuated simultaneously to cause straight-line movement of said base blow-mold subassembly movable gutter plate relative to said base blow-mold sub-assembly product mold to thereby separate integrally attached gutter flash from the blow-molded thermoplastic resin product at said base blow-mold sub-assembly product mold cavity parting line perimeter.

15. The blow-molding machine apparatus invention defined by claim 11, and further comprising multiple second bi-directional actuators that are each carried by said cap blow-mold subassembly, that are each connected to said cap blow-mold sub-assembly pivoted gutter plate, and that are each actuated simultaneously to cause straight-line movement of said cap blow-mold sub-assembly gutter plate relative to said cap blow-mold sub-assembly product mold to thereby remove separated gutter flash from frictional contact with said cap blow-mold sub-assembly product mold.

16. The blow-molding machine apparatus invention defined by claim 15, and wherein simultaneous actuation of each of said multiple first bi-directional actuators to cause straight-line movement of said base blow-mold sub-assembly movable gutter plate to effect gutter flash separation from blow-molded thermoplastic resin product also causes straight-line movement of said cap blow-mold sub-assembly movable gutter plate against forces originated by each of said multiple second bi-directional actuators.

17. The blow-molding machine apparatus invention defined by claim 11, and wherein said base blow-mold sub-assembly gutter plate is provided in its gutter flash-contacting surface with multiple spaced-apart gutter flash resinous material reservoir recesses each extending generally radially outwardly from said base blow-mold sub-assembly gutter plate product mold opening.

18. The blow-molding machine apparatus invention defined by claim 11, and wherein said cap blow-mold sub-assembly gutter plate is provided in its gutter flash-contacting surface with multiple spaced-apart gutter flash resinous material reservoir recesses each extending generally radially outwardly from said cap blow-mold sub-assembly gutter plate product mold opening.

19. The blow-molding machine apparatus invention defined by claim 11, and further comprising coolant passageways contained within said base-blow-mold sub-assembly movable gutter plate, coolant passageways contained within said cap blow-mold sub-assembly movable gutter plate, coolant passageways contained within each said base blow-mold sub-assembly product mold, and coolant passageways contained within each said cap blow-mold sub-assembly product mold, said coolant passageways contained within said blow-mold sub-assembly product molds each being located in proximity to a respective blow-mold sub-assembly product mold cavity mold parting line perimeter.

20. The blow-molding machine apparatus invention defined by claim 12, and wherein the apparatus is further comprised of a variable actuator sequence controller, said variable actuator sequence controller being varied to actuate said first and second bi-directional actuators sequentially.

21. Co-operating blow-mold sub-assemblies for use in producing flash-free blow-molded thermoplastic resin products, comprising:
a base blow-mold sub-assembly product mold;
a base blow-mold sub-assembly movable base gutter plate having a product mold opening that surrounds and is moved in a straight line relative to said base blow-mold subassembly product mold; and
a cap blow-mold sub-assembly product mold; and
a cap blow-mold sub-assembly movable cap gutter plate having a product mold opening that surrounds and is moved in a straight line relative to the cap blow-mold subassembly product mold,
said base and cap blow-mold sub-assembly product molds each having a complementary product mold cavity with a like-configured product mold parting line perimeter, each having a mold perimeter wall that is congruent with and positioned radially outwardly of its respective product mold cavity parting line perimeter, said base blow-mold sub-assembly product mold perimeter wall being positioned a further lateral distance from said product mold parting line perimeter than is said cap blow-mold sub-assembly product mold perimeter wall.

22. The co-operating blow-mold assemblies invention defined by claim 21, and wherein said base blow-mold sub-assembly product mold perimeter wall lateral distance from said cap blow-mold sub-assembly product mold perimeter wall is in the range of approximately one-quarter inch to one-half inch.

23. The co-operating blow-mold assemblies invention defined by claim 21, and wherein a relief region is created between said cap blow-mold sub-assembly product mold perimeter wall and said base blow-mold sub-assembly base gutter plate product mold opening as said base gutter plate is moved linearly relative to said cap blow-mold sub-assembly product mold, said relief region receiving gutter flash separated from a blow-molded thermoplastic resin product by said base blow-mold sub-assembly base gutter plate to form the flash-free blow-molded thermoplastic resin product.

24. The blow-molding machine apparatus invention defined by claim 21, and further comprising a gutter flash tapered transition tab-defining zone separating each said base blow-mold sub-assembly product mold from its respective cap blow-mold sub-assembly product mold, said gutter flash transition tab zone being defined by a first surface that extends outwardly from said cap blow-mold sub-assembly product mold parting line perimeter a first distance toward said cap blow-mold sub-assembly product mold perimeter wall, also being defined by a second surface that extends outward from said base blow-mold sub-assembly product mold parting line perimeter a second distance toward said base blow-mold sub-assembly product mold perimeter wall, and tapering with increasing separation of said first and second definition surfaces outwardly from said base and cap blow-mold sub-assembly product mold parting line perimeters toward said base and cap blow-mold sub-assembly product mold perimeter walls, said second distance being measurably greater than said first distance.

25. The blow-molding machine apparatus invention defined by claim 24, and further comprising multiple spaced-apart gutter flash transition tab zone partitions that integrally project from either said base blow-mold assembly product mold or said cap blow-mold assembly product mold and extend transversely of said transition tab zone, said gutter flash transition tab zone partitions segmenting said gutter flash transition tab zone along said product mold parting line perimeter.

26. The blow-molding machine apparatus invention defined by claim 24, and wherein one of said multiple spaced-apart gutter flash transition tab partitions is positioned at each angled parting line departures along said product mold parting line perimeter.

27. The blow-molding machine apparatus invention defined by claim 25, and wherein said multiple spaced-apart gutter flash transition tab partitions are positioned at curved parting line departures along said product mold parting line perimeter.

28. The blow-molding machine apparatus invention defined by claim 26, and wherein compression forces originating with said first bi-directional actuator and applied to integrally attached gutter flash by said base blow-mold sub-assembly movable gutter plate are developed within said gutter flash transition tab zone into tension forces that separate said integrally attached gutter flash from said fully-restrained blow-molded thermoplastic resin product at said product mold parting line perimeter.

29. The blow-molding machine apparatus invention defined by claim 28, and wherein said base blow-mold sub-assembly movable gutter plate moves said separated integrally attached gutter flash into frictional retention by and upon an external surface of said cap blow-mold sub-assembly product mold perimeter wall.

30. Apparatus for installation in a blow-molding machine to produce a blow-molded thermoplastic resin product, comprising:
a base blow-mold sub-assembly having a product mold with a product cavity defined in-part by a product mold parting line perimeter, and having oppositely positioned linearly movable gutter plates that are each moved in a straight line relative to said base mold assembly product mold in a plane that is parallel to the plane of said base mold assembly product mold cavity parting line perimeter, that has a product opening larger than, congruent with, and surrounding a portion of said base blow-mold product mold cavity mold parting line perimeter;
a cap blow-mold sub-assembly co-operating with said base blow-mold sub-assembly and having a product mold with a product cavity that is complementary to said base blow-mold sub-assembly product mold cavity and that is defined in part by a product mold parting line perimeter that corresponds to said base blow-mold sub-assembly product mold parting line perimeter; and
bi-directional actuators that are carried by said base blow-mold assembly, that are each connected to a base blow-mold sub-assembly movable gutter plate, and that are each actuated to cause straight-line movement of at least one of said base-blow-mold sub-assembly movable gutter plates relative to said base blow-mold sub-assembly product mold to thereby separate integrally attached gutter flash from the blow-mold thermoplastic resin product at said base blow-mold sub-assembly product mold cavity parting line perimeter.

31. The apparatus invention defined by claim 30, and further comprising a variable actuator sequence controller, said variable actuator sequence controller being varied to actuate said bi-directional actuators simultaneously.

32. The apparatus invention defined by claim 30, and further comprising a variable actuator sequence controller, said variable actuator sequence controller being varied to actuate said bi-directional actuators sequentially.

33. The apparatus invention defined by claim 30, and wherein said base blow-mold subassembly linearly movable gutter plates are each provided with multiple spaced-apart integral gutter flash edge retainers, and said cap blow-mold sub-assembly product mold is provided with an integrally attached lip that surrounds said complementary cap blow-mold sub-assembly product mold cavity and that overlaps said base blow-mold sub-assembly movable gutter plates in their linearly moved positions caused by actuation of said bi-directional actuators, said pivoted gutter plate integral surface protrusions extending from a pivoted gutter plate surface positioned adjacent and toward said cap blow-mold sub-assembly product mold integrally attached lip.

34. In blow-molding apparatus having base and cap blow-mold sub-assemblies that cooperate to form a blow-molded thermoplastic resin product with integrally attached gutter flash, a pair of linearly movable, liquid-cooled, gutter plates that comprise part of the base and cap blow-mold sub-assemblies and that function to separate the integrally attached gutter flash from the blow-molded thermoplastic resin product while the base and cap blow-mold sub-assemblies are operationally closed.
